(19) United States
(12) Patent Application Publication
(10) Pub. No.: US 2026/0098773 A1
(43) Pub. Date: Apr. 9, 2026

(54) METHOD FOR MONITORING THE FUNCTION OF A PRESSURE MEASURING DEVICE

(71) Applicant: IFM ELECTRONIC GMBH, Essen (DE)

(72) Inventors: Kai BESCHORNER, Ravensburg (DE); Jonathan HEEP, Weingarten (DE)

(73) Assignee: IFM ELECTRONIC GMBH, Essen (DE)

(21) Appl. No.: 19/354,431

(22) Filed: Oct. 9, 2025

(30) Foreign Application Priority Data
Oct. 9, 2024 (DE) 102024129151.6

(51) Int. Cl. G01L 9/00; G01L 27/00

(52) U.S. Cl. CPC G01L 9/0052; G01L 27/007

(57) ABSTRACT

A method monitors the function of a pressure measuring device with a measuring element composed of a semiconductor substrate and a measuring bridge consisting of at least one piezoresistive resistance track. The semiconductor substrate has an n-conducting layer and a p-conducting layer and four first connection pads are connected to the p-conducting layer for electrically contacting the measuring bridge.

At least one of the four electrical lines is connected to a switch unit to switch between a pressure measurement mode and a diagnostic mode, and the semiconductor substrate has a further connection pad connected to the n-conducting layer. A microcontroller detects a forward voltage between the n-conducting and p-conducting layers by being connected to at least one of the four electrical lines at a point P and measuring, in diagnostic mode, the voltage drop between this point P and the further connection pad.

A pressure measuring device performs function monitoring.

The invention relates to a method for monitoring the function of a pressure measuring device according to the preamble of claim 1, and to a pressure measuring device according to the preamble of claim 7.

Pressure measuring devices or pressure sensors are used to monitor and measure system pressure in hydraulic and pneumatic applications. One area of application for such pressure measuring devices is, for example, the food industry, where the pressure of various media, in particular liquids, is monitored or measured. Depending on the application, there are a variety of different designs, with the structure and design of the pressure measuring devices varying depending on the expected maximum nominal pressure of the medium to be monitored.

Typically, such pressure measuring devices consist of a metallic process connection for the mechanical connection of the measuring device to the container containing the medium, and a housing mounted on the process connection, which substantially contains the evaluation electronics. Furthermore, a pressure measuring cell, usually metal or ceramic, is provided for converting the pressure to be monitored into a proportional measurement signal using an electromechanical transducer. The pressure measuring cell has at least one deflectable measuring diaphragm, one side of which is in contact with the medium and on the other side of which, facing away from the medium, the electromechanical transducer is arranged.

One possible way to detect pressure is to utilize the so-called piezoresistive effect. For this purpose, the measuring element for pressure detection consists of a semiconductor substrate, preferably made of silicon, and a measuring bridge with at least one piezoresistive resistance track. The semiconductor substrate has an n-conducting layer and a p-conducting layer.

Typically, four connection pads are arranged on the p-conducting layer for electrically contacting the measuring bridge.

Highly sensitive electrical lines, such as bonding wires, are often used for this purpose. In order to detect an interruption in these lines, a redundant structure using a second measuring element has been provided, for example, or the response of the measuring element has been verified using an additional LED.

Document DE 10 2021 104 607 A1 discloses a pressure sensor and an associated operating method for covering an extended measuring range with a single sensor element. This is achieved by switching the sensor between at least two operating modes, wherein in each mode a different measuring capacitance is formed, by a different electrical connection of the electrodes, in order to detect a specific pressure range.

The object of the invention is to allow a reliable verification of the uninterrupted contact of the measuring element intended for pressure measurement.

The object is achieved according to the invention by a method having the features of claim 1 and by a pressure measuring device having the features of claim 7. Advantageous embodiments of the invention are specified in the dependent claims.

The starting point of the invention is pressure detection using the so-called piezoresistive effect. For this purpose, the measuring element for pressure detection consists of a semiconductor substrate, preferably a silicon chip, and a measuring bridge with at least one piezoresistive resistance track. The semiconductor substrate has an n-conducting layer and a p-conducting layer. Four first connection pads are arranged on the p-conducting layer for electrically contacting the measuring bridge.

According to the invention, at least one of the four electrical lines provided for contacting the measuring bridge is connected to a switch unit, preferably designed as a multiplexer, configured to switch between a pressure measurement mode and a diagnostic mode. Furthermore, the semiconductor substrate has a further connection pad connected to the n-conducting layer. Between the p- and n-type dopings, the semiconductor substrate has a parasitic diode path (body diode) that is not used for pressure measurement. The invention utilizes this diode path to verify the uninterrupted contact of the measuring element intended for pressure measurement. For this purpose, a microcontroller detects a forward voltage between the n-conducting and p-conducting layers by being connected to at least one of the four electrical lines at a point P and measuring, in diagnostic mode, the voltage drop between this point P and the further connection pad.

To this end, the semiconductor substrate is set to the lowest potential and a constant current or voltage is applied to one of the first four connection pads connected to the p-doped layer. This allows the forward voltage of the diode path to be measured. If the connection between one of the connection pads is interrupted, this voltage can no longer be measured. This makes it possible to determine which connection is interrupted and whether there is a fault with the chip or its connection to the evaluation electronics.

Advantageous developments of the invention provide for the switch unit to be controlled by the microcontroller or for the microcontroller to be connected to all four electrical lines. By controlling the switch unit designed as a multiplexer, the microcontroller can sequentially select each of the four electrical lines in diagnostic mode and check them individually. This not only allows the determination of the presence of an interruption, but also the precise identification of which of the four lines is faulty, which significantly improves fault diagnosis.

According to the invention, in a second aspect, the pressure measuring device comprises, in addition to the measuring element with its semiconductor substrate, a switch unit, an additional connection pad for the n-conducting layer of the substrate, and a microcontroller. The switch unit is designed to switch between the normal pressure measurement mode and a diagnostic mode. The microcontroller is configured such that it measures, in diagnostic mode, the voltage between one of the lines to the p-conducting layer and the new connection pad of the n-conducting layer. This arrangement uses the inherent parasitic diode path of the semiconductor substrate to check the integrity of the electrical contact of the measuring element by measuring the forward voltage.

In a preferred embodiment of the pressure measuring device, the switch unit is designed as a multiplexer. The advantage of this implementation lies in the efficient and space-saving realization of the switching function between the different electrical lines. A multiplexer allows several lines to be connected and disconnected sequentially or selectively using a comparatively small number of switching components. This contributes to the miniaturization of the device and reduces the complexity of the circuit, which in turn can reduce manufacturing costs.

A further advantageous development of the pressure measuring device provides that the microcontroller is designed to control the switch unit. This allows fully automated and precise control over switching between pressure measurement mode and diagnostic mode. Microcontroller control ensures precise timing of diagnostic cycles, seamless integration into the overall control of the system, and the option to perform diagnostic tests without manual intervention, which significantly increases operational reliability and convenience.

A particularly advantageous embodiment is one in which the microcontroller can be selectively connected to each of the four electrical lines via the switch unit in order to check the integrity of each line individually. This approach allows extremely precise fault localization. In the event of an interruption, it is possible to not only determine that there is a fault, but also to identify exactly which of the lines is affected. This significantly simplifies troubleshooting and maintenance, reduces downtime, and allows targeted repairs, significantly improving the reliability of the pressure measuring device and the higher-level system.

In order to standardize and optimize the measurement of the forward voltage in diagnostic mode, the microcontroller is designed to apply a constant current or a constant voltage to the connection pads. The use of a constant current or constant voltage during the measurement ensures reproducible and comparable measurement results. This leads to more reliable detection of changes in the diode characteristic curve that indicate an interruption or degradation of the electrical connections, thus increasing the accuracy of functional monitoring.

In a further preferred embodiment, the semiconductor substrate consists of silicon and/or the electrical lines are formed as bonding wires. Silicon as a substrate material offers the advantage of an established and cost-effective manufacturing technology with excellent mechanical and electrical properties that are ideal for precise pressure sensors. The use of bonding wires for electrical lines is a common and proven method for producing sensitive connections in semiconductor devices. It allows a high integration density and is well suited to reliably transmit the low signal levels of the measuring bridge, but also contributes to the potential error sources monitored by the present invention.

The invention thus creates a pressure measuring device with an integrated self-monitoring function that offers significantly increased operational safety and reliability. A key advantage of this device is that it allows diagnosis of the electrical connection of the measuring element in a particularly elegant and resource-saving manner. Instead of using complex redundant structures or additional sensor elements, the pressure measuring device according to the invention uses a parasitic semiconductor structure within the measuring element that is already present but unused during normal operation. Through intelligent control using a microcontroller and a switch unit, this structure is specifically activated for a diagnostic measurement. This not only allows for easy detection of a connection fault, but also allows precise identification of the faulty line. The ability to accurately localize faults represents a significant advance as it simplifies maintenance and significantly improves the overall safety of the system in which the pressure measuring device is used.

The invention is explained in more detail below using exemplary embodiments with reference to the drawings,

in which:

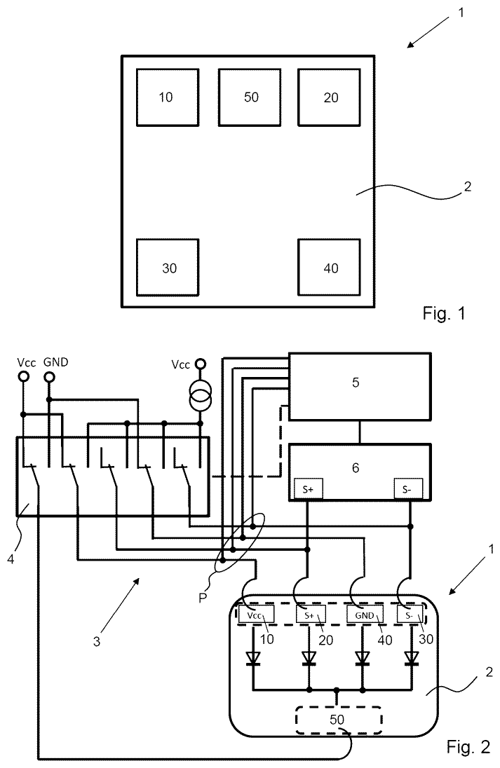

FIG. 1 is a schematic plan view of a measuring element;

FIG. 2 schematically shows the structure for carrying out the method according to the invention.

In the following description of the preferred embodiments, the same reference signs denote the same or comparable components.

In the highly schematic representation in FIG. 1, a measuring element 1 according to the invention is shown in plan view, which measuring element is arranged on the diaphragm of a pressure measuring cell for detecting the pressure of a liquid, flowable or gaseous medium. It substantially consists of a semiconductor substrate 2 with an n-conducting layer and a p-conducting layer. Four of the five connection pads 10, 20, 30, 40 shown are connected to the p-conducting layer. Between these four connection pads 10, 20, 30, 40, piezoresistive resistance tracks (not shown in the figure) are arranged, which together form a measuring bridge. The connection pads 10, 20, 30, 40 serve for electrically contacting this measuring bridge. An applied pressure causes a deflection of the diaphragm, which can be detected by a change in the resistance of the piezoresistive resistance tracks 4 and evaluated using the measuring bridge. This measuring principle is well known.

The semiconductor substrate 2 has a further connection pad 50 connected to the n-conducting layer. A microcontroller 5 can be connected between this further connection pad 50 and one of the four first connection pads 10, 20, 30, 40, which microcontroller is configured to detect a forward voltage between the n-conducting and p-conducting layers, thus allowing the detection of an uninterrupted contact of the measuring element 1.

FIG. 2 shows an exemplary structure with which the method according to the invention can be carried out. The central elements for pressure measurement are the measuring element 1 and an evaluation unit 6 connected to the measuring element 1. In addition, the measuring element 1 is connected to the supply voltage Vcc and ground GND.

As already mentioned, the measuring element 1 substantially consists of a semiconductor substrate 2 designed as a chip with an n-conducting layer and a p-conducting layer. The semiconductor substrate 2 comprises a measuring bridge (not shown in detail) consisting of four piezoresistive resistance tracks with the terminals 10, 20, 30, 40, which can be contacted via the connection pads shown in FIG. 1. Contact is made via a sensitive bond wiring, which is characterized by the semicircular shape of the line.

A microcontroller 5 and a switch unit 4 designed as a multiplexer are provided for reliable wiring testing. The corresponding connections for supplying the microcontroller 5 and for tapping the measurement signals, for example, for forwarding to a higher-level control unit (PLC), have been omitted.

Firstly, the microcontroller 5 controls the switch unit 4, which is represented by the dashed connecting line, and can thus switch between a pressure measurement mode and a diagnostic mode. The pressure measurement takes place in the pressure measurement mode, while in the diagnostic mode, in which the actual pressure measurement is briefly paused for the duration of the diagnosis, the uninterrupted contact of the measuring element 1 is checked. For this purpose, the microcontroller 5 compares the measured diode voltage with an expected threshold value in order to reliably detect an error, for example an interruption in the line.

The diode path between terminals 10, 20, 30, 40 and the further terminal 50 is indicated by a corresponding symbol. The forward voltage drop across this diode path is detected by the microcontroller 5 by it being connected to at least one of the four electrical lines 3 at a point P, which is located, with respect to signals, between the switch unit 4 and the microcontroller 5 (see the oval circling) and measuring the voltage drop between this point P and the further connection pad 50.

### LIST OF REFERENCE SIGNS

1 Measuring element
2 Semiconductor substrate
5 3 Electrical cable
4 Switch unit, multiplexer
5 Microcontroller
6 Evaluation unit
10 Connection pad Vcc
20 Connection pad S+
30 Connection pad S−
40 Connection pad GND
50 Connection pad substrate

1. A method for monitoring the function of a pressure measuring device for detecting the pressure of a liquid, flowable or gaseous medium, comprising a pressure measuring cell with a deflectable measuring diaphragm, one side of which is in contact with the medium and a measuring element is arranged on a second side facing away from the medium, wherein the pressure to be monitored is converted into a proportional measuring signal,
wherein the measuring element includes a semiconductor substrate and a measuring bridge with at least one piezoresistive resistance track,
wherein the semiconductor substrate has an n-conducting layer and a p-conducting layer, and four first connection pads are connected to the p-conducting layer for electrically contacting the measuring bridge;
at least one of the four electrical lines provided for contacting the measuring bridge is connected to a switch unit configured to switch between a pressure measurement mode and a diagnostic mode,
and in that the semiconductor substrate has a further connection pad connected to the n-conducting layer,
wherein a microcontroller is configured to detect a forward voltage between the n-conducting and p-conducting layers by being connected to at least one of the four electrical lines at a point P and measuring, in diagnostic mode, the voltage drop between this point P and the further connection pad.

2. The method according to claim 1,
wherein the switch unit is a multiplexer.

3. The method according to claim 1, wherein the switch unit is controlled by the microcontroller.

4. The method according to claim 1, wherein the microcontroller is connected to all four electrical lines.

5. The method according to claim 1, wherein measuring the voltage in the diagnostic mode includes feeding a constant current or a constant voltage into one of the four first connection pads.

6. The method according to claim 1, further comprising the step of determining whether there is an interruption in one of the electrical lines, based on the measured voltage.

7. A pressure measuring device for function monitoring to perform the method according to claim 1, comprising a pressure measuring cell with a deflectable measuring diaphragm, one side of which is in contact with a medium, and on the second side of which, facing away from the medium, a measuring element converts the pressure to be monitored into a proportional measuring signal,
wherein the measuring element includes a semiconductor substrate and a measuring bridge including at least one piezoresistive resistance track,
wherein the semiconductor substrate has an n-conducting layer and a p-conducting layer, and four first connection pads are connected to the p-conducting layer for electrically contacting the measuring bridge,
a switch unit, which is connected to at least one of the four electrical lines provided for contacting the measuring bridge and is configured to switch between a pressure measurement mode and a diagnostic mode,
a further connection pad on the semiconductor substrate which is connected to the n-conducting layer,
and a microcontroller, which is configured to detect a forward voltage between the n-conducting and p-conducting layers by being connected to at least one of the four electrical lines at a point P and measuring, in diagnostic mode, the voltage drop between this point P and the further connection pad.

8. The pressure measuring device according to claim 7
wherein the switch unit is a multiplexer.

9. The pressure measuring device according to claim 7,
wherein the microcontroller controls the switch unit.

10. The pressure measuring device according to claim 7, wherein the microcontroller is selectively connected to each of the four electrical lines via the switch unit in order to check the integrity of each line individually.

11. The pressure measuring device according to claim 7, wherein the microcontroller applies a constant current or a constant voltage to one of the four first connection pads in the diagnostic mode in order to measure the forward voltage.

12. The pressure measuring device according to claim 7, wherein the semiconductor substrate includes silicon and/or the electrical lines bonding wires.
